(19) United States
(12) Patent Application Publication
(10) Pub. No.: US 2014/0152560 A1
(43) Pub. Date: Jun. 5, 2014

(54) SYSTEMS FOR CHANGING ORIENTATION OF DISPLAYED CONTENT

(71) Applicant: EMO2 INC., Palo Alto, CA (US)

(72) Inventor: Mir Abid HUSSAIN, Kerala (IN)

(73) Assignee: EMO2 INC., Palo Alto, CA (US)

(21) Appl. No.: 13/690,899

(22) Filed: Nov. 30, 2012

(51) Int. Cl. G06F 3/041; G06F 3/033

(52) U.S. Cl. CPC G06F 3/041; G06F 3/033
USPC 345/158

(57) ABSTRACT

In a multiuser touch sensitive device including an orientation module capable of providing touch interfaces and a touch sensitive display screen for displaying a content wherein the device enables users to provide touch sensitive inputs through the display screen and wherein not all users are oriented in a same direction with respect to the device and to the content, a method for changing an orientation of the content without changing an orientation of the device is provided. The method includes receiving a touch sensitive input from one of the touch interfaces, wherein the input is provided by one of the users using single object for changing the orientation of the content; and processing the touch sensitive input at the orientation module for changing the orientation of the content such that the content can be oriented towards at least one of the users for viewing the content at a desired orientation.

### CROSS REFERENCE TO RELATED APPLICATIONS

This application is related to the following applications filed concurrently herewith on Nov. 30, 2012:

U.S. patent application Ser. No. ______, entitled “Systems and Methods for Controlling a User's Ability to Browse the Internet;”

U.S. patent application Ser. No. ______, entitled “Systems and Methods for Authenticating a User Based on Multiple Inputs Received from Multiple Devices;”

U.S. patent application Ser. No. ______, entitled “Systems and Methods for Selectively Delivering Messages to Multiuser Touch Sensitive Display Devices;”

U.S. patent application Ser. No. ______, entitled “Systems and Methods for Processing Simultaneously Received User Inputs;” and

U.S. patent application Ser. No. ______, entitled “Apparatus and Methods for Mounting a Multiuser Touch Sensitive Display Device.”

### FILED OF THE INVENTION

The disclosed subject matter relates to the field of touch sensitive devices, pen based input devices and gesture based devices, and more particularly but not exclusively to changing orientation and hiding of content or applications displayed in touch sensitive or gesture input based or pen input based devices among others. Examples of other devices include traditional mouse input based devices. Touch input based devices may include both capacitive, IR and in-cell technology based displays.

### DISCUSSION OF THE RELATED FIELDS

Conventionally, digital displays display content in either landscape or portrait orientation. While content is displayed in one such orientation, changing the orientation of content can lead to better portrayal of the content.

Several conventional technologies exist that enable changing orientation of content displayed in touch sensitive devices. In one such technology, the device is configured with an accelerometer, which determines the orientation of the device. Any change in orientation of the device results in corresponding change in orientation of the content displayed by the device. Hence, the orientation of the content cannot be changed without changing the orientation of the device. Further, there could be a scenario wherein one would want to change the orientation of the content, while retaining the original orientation of the device, which is not possible using the instant technology.

The need to change the orientation of the content without changing the orientation of the device has been identified, and an approach to address this problem is disclosed in U.S. Pat. No. 8,209,606 (US '606) granted to Ording, Bas. US '606 discloses techniques of changing orientation of content by using gestures. A gesture to change the orientation is made using two fingers. To change the orientation of the content, two fingers are placed on the touch sensitive display and moved substantially in the opposite directions. In this technique, the orientation can only be changed in the multiples of 90°, and by a maximum of 90° at a given instance. Hence, if a user wishes to change the orientation by 180° then he will have to perform the above described action twice. Further, the user will have to use two fingers to change the orientation. Also it is worth noting that U.S. Pat. No. 8,209,606 is only applicable to changing orientation of content within a display screen.

### SUMMARY

Accordingly, there is a need for a technique to enable changing of orientation of content in touch sensitive devices without changing the orientation of the device. Further, there is a need to enable changing of orientation of content, applications and overall orientation in a relatively user friendly manner. The invention provides a system for changing orientation of content, individual windows and overall orientation displayed by a display device. For easy understanding, we will use the example of a touch sensitive display however this does not limit the scope of the invention to a touch display device alone. The system includes an orientation module, wherein the orientation module is configured to receive input from a single object, wherein the input indicates the desire to change the orientation of either content, individual windows or the overall orientation of the display device. The system further includes a processing module, which processes the received input and changes the orientation.

When content is being viewed by multiple users on a device, enabling changing of orientation can enable users to conveniently view the content, especially when all the users are not oriented in the same direction with respect to the device. For example a touch screen device that takes the shape of a coffee table, placed in a café where users are seated on either side of the table interacting with the same touch screen available towards the centre of the table-top. It is also possible to change the orientation of an application window in addition to being able to change the orientation of an entire display screen.

Another example is that when there are two users seated on either side of a touch enabled coffee table, either user may use apps independent of each other. User 1 may play a game while user 2 may read the news. While doing so the user 2 may wish to change orientation of the news application to share a breaking news story with user 1. Another case is when there is touch display attached to a table which has content oriented in one direction. A user who may be seated on the other side of the table may choose to either turn specific content towards him or he may choose to change the whole screen orientation to orient the display including all the content on the screen towards him.

In a multiuser touch sensitive device including an orientation module capable of providing at least one touch interface and a touch sensitive display screen for displaying a content wherein the multiuser touch sensitive display device enables a plurality of users to provide touch sensitive inputs through the touch sensitive display screen and wherein not all of the plurality of users are oriented in a same direction with respect to the multiuser touch sensitive display device and to the displayed content, a method for changing an orientation of the displayed content without changing an orientation of the multiuser touch sensitive display device is provided. The method includes: receiving a touch sensitive input from one of the at least one touch interface, wherein the touch sensitive input is provided by one of the plurality of users using a single object for changing the orientation of the displayed content; and processing the received touch sensitive input at the orientation module for changing the orientation of the displayed content such that the displayed content can be oriented towards at least one of the plurality of users for viewing the displayed content at a desired orientation.

### BRIEF DESCRIPTION OF DRAWINGS

Embodiments are illustrated by way of example and not limitation in the Figures of the accompanying drawings, in which like references indicate similar elements and in which:

FIG. 1 illustrates a block diagram of a touch sensitive device 100, in accordance with an embodiment;

FIG. 2 illustrates a table 202 configured with device 100 (only touch sensitive display 102 is visible) is accordance with an embodiment;

FIG. 3 illustrates an orientation module 302 configured to change the overall orientation of the display 102, in accordance with an embodiment;

FIG. 4 illustrates an alternate embodiment of the orientation module 302 configured to change the orientation of the entire display 102, in accordance with an embodiment;

FIG. 5 illustrates gestures made on the orientation module 302, in accordance with an embodiment;

FIG. 6 illustrates more than one application in open state and users change the orientation of the application windows independent of the display 102 in accordance with an embodiment;

FIG. 7 illustrates the orientation module 302 in accordance with an embodiment which maybe uses to orient the entire screen including all the content and windows on the screen in a any direction; and

FIG. 8 illustrates an embodiment of the orientation module whereby the user can change the orientation of some content on the display 302 in accordance with an embodiment.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

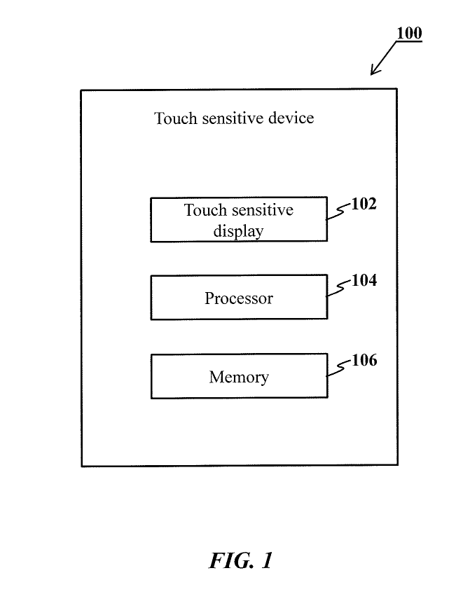

Embodiments disclosed technique for changing orientation of content displayed by touch sensitive devices. FIG. 1 illustrates a block diagram of a touch sensitive device 100, in accordance with an embodiment. The device 100 includes a touch sensitive display 102, a processing module 104 and a memory module 106. The device 100, for example, can be a telecommunication device, laptop computer, desktop computer, television, tablet PC, table mounted device and a wall mounted device, among other devices.

The touch sensitive display 102 provided in device 100 can be implemented using technologies like resistive touch screen, surface acoustic wave, in-cell technology and capacitive sensing technology, among other technologies.

The processing module 104 in the device 100 is configured to receive inputs provided through the touch sensitive display 102. The processing module 104 processes the received input in accordance with the instructions stored in the memory module 106, associated with the processing module 104.

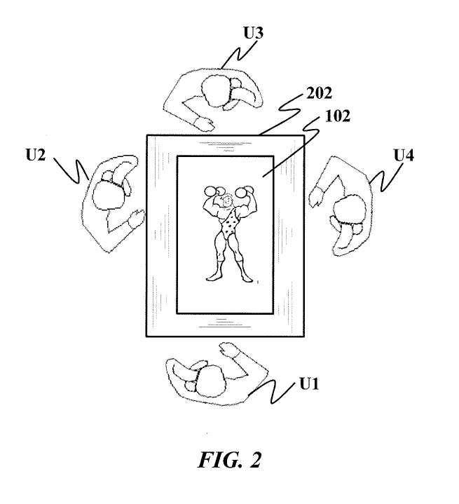

Referring to FIG. 2, wherein FIG. 2 illustrates a table 202 configured with device 100 (only touch sensitive display 102 is visible) is accordance with an embodiment. Table 202 may be a cafe table. Table 202 is configured to accommodate device 100. As illustrated in FIG. 2, multiple users U1, U2, U3 and U4 are seated at table 202. As evident from the illustration, the content in the touch sensitive display 102 is oriented towards user U1. The other users are not able to properly view the content on display 102. For user U2 to view the content on the display 102 in the most preferred orientation, it would be desirable to have the content on the display oriented towards him. Similarly other users would desire to orient the display towards them to view the content in their most preferred orientation.

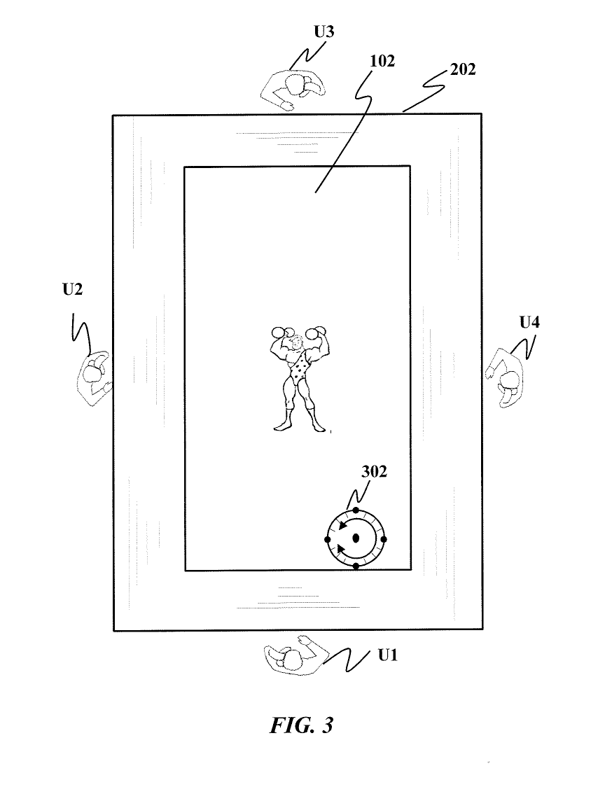

Referring to FIG. 3, wherein FIG. 3 illustrates an orientation module 302 configured to change the orientation of the display 102, in accordance with an embodiment. Orientation module 302 enables the user to change the orientation of the overall display 102. The orientation can be changed in both clockwise and anticlockwise direction. The orientation module 302 includes a touch interface. The orientation can be changed to the preferred orientation of the users. The users can change the orientation of the display by performing touch sensitive actions on the orientation module 302. Touch sensitive actions can be, for example, touching the touch interface of the orientation module 302 using a finger or an object, such as a stylus, pen or digitizer, or positioning an object in proximity to the touch interface, which can be interpreted as a gesture or input.

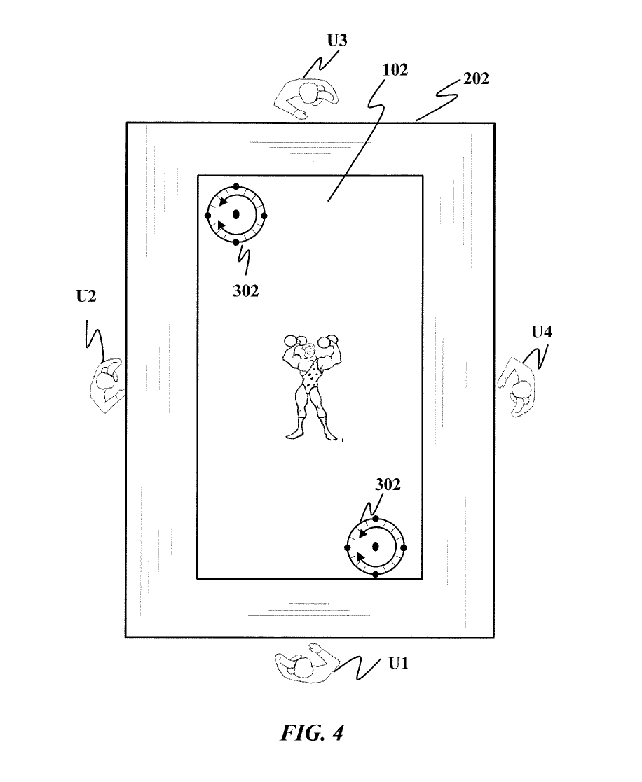

Referring to FIG. 4, wherein FIG. 4 illustrates an alternate embodiment of the orientation module 302 configured to change the orientation of the content on the display 102, in accordance with an embodiment. The alternate embodiment discloses the orientation module 302 positioned at multiple corners of the display 102. This enables users on all sides of the table to access the orientation module 302 and orient the display towards their preferred orientation.

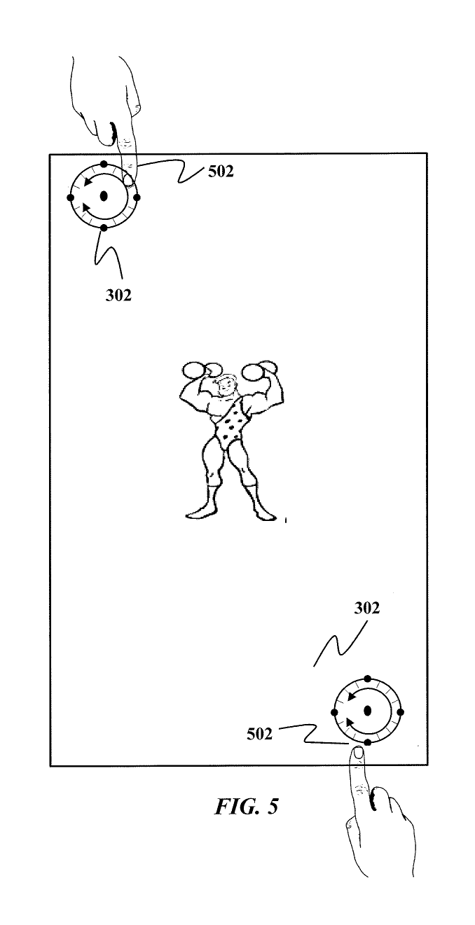

Referring to FIG. 5, wherein FIG. 5 illustrates gestures made on the orientation module 302, in accordance with an embodiment. The orientation module 302 is configured to receive both touch and non touch instructions. In an embodiment, when gestures are made by a finger 502 or other input objects, the orientation of the content on the display 102 changes. For example, the gesture can be in the form of making a circular motion. The circular motion can correspond to the degree of rotation desired. If the desired degree of rotation of the content on the screen is 90 degree, the rotation can be for quarter circle. Alternatively, the gesture can be in the form of making a linear motion. The linear motion can correspond to the degree of rotation desired. For example, the start point of the linear motion corresponds to the current orientation of the content and the end point of the linear motion corresponds to the desired orientation of the content.

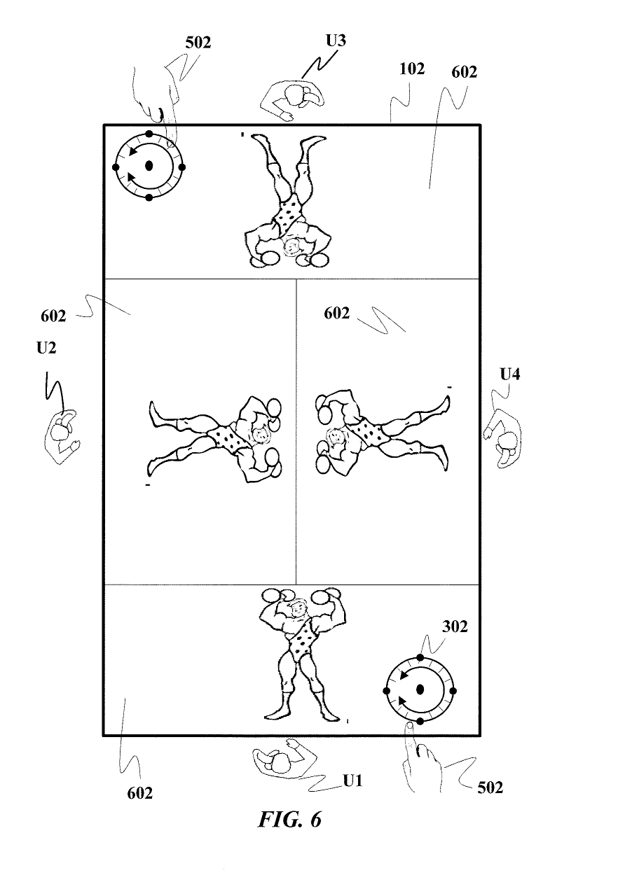

Referring to FIG. 6, wherein FIG. 6 illustrates more than one application in open state and users change the orientation of the application windows independent of the display 102 in accordance with an embodiment. The orientation module 302 can also be provided with an option of dividing the display into multiple displays 602, with the content in each of multiple displays 602 preferably oriented towards the respective users' preferred orientation. Further the orientation module 302 enables the users to view the content on display 102 through multiple displays 602. The content and applications is oriented towards the users to enable comfortable viewing of the content.

In an embodiment, the content displayed in each of the multiple displays 602 can be the same content. In an alternate embodiment, the content displayed in each of the multiple displays 602 can vary based on user inputs. The division of the display 102 into multiple displays 602 facilitates easier sharing of the content among the users. In an alternate embodiment, the apps opened by one user maybe different from the apps opened by the other user.

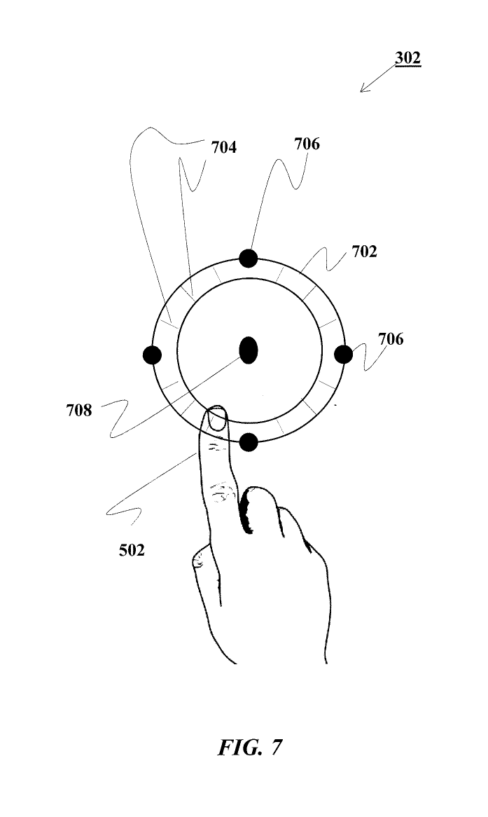

Referring to FIG. 7, wherein FIG. 7 illustrates the orientation module 302 in accordance with an embodiment. Orientation module 302 may include reference circle 702, angle of rotation indicator 704, one touch rotation button 706 and one touch multiple display button 708. The reference circle 702 acts as a guide to enable the user to carry out the gesture of circling, using a single finger or object. The user need not follow the path of the reference circle 702. The angle of rotation indicator 704 indicates various angles. The user can make a circling gesture, which traces the path of the reference circle 702. The tracing of the path of the reference circle 702 can be till the desired angle of rotation indicated by the angle of rotation indicator 704. The content on the display 102 is rotated till the indicated angle. The one touch rotation button 706 is configured to enable users to rotate the content on display 102 by a single touch. This button may also be configured to change the orientation of the entire screen. The content on the display 102 is rotated to the selected orientation, when a user touches any of the one touch rotation buttons 706. The single touch can be enabled using a finger or an object. The one touch multiple display button 708 is configured to enable users to change the display into multiple displays 602. The content on the multiple displays 602 are oriented towards the users on each side. The display 102 is divided into multiple displays 602, when a user touches the one touch multiple display button 708. The content is displayed on each of the multiple displays 602.

In an embodiment, the user can touch a point on the reference circle 702 indicated by the angle of rotation indicator 704 and the content is rotated by the desired angle. This enables rotation of the content on the display 102 to a desired angle by a single touch.

In an embodiment, when the content on the display 102 is rotated, the content stays within the boundaries of the display 102. The content may be minimized or enlarged automatically to fit the display 102 screen.

In an embodiment, the orientation module 302 may be illuminated to provide better visibility to the user. The illumination may be integrated into the device 100.

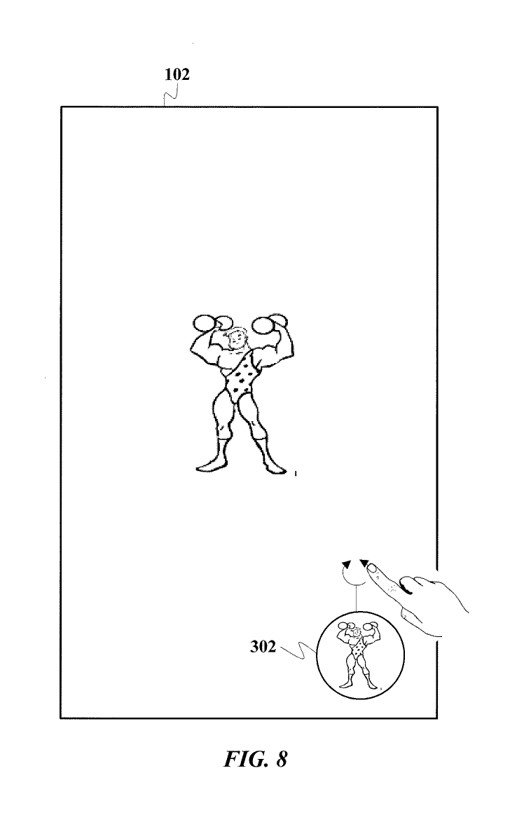

Referring to FIG. 8, wherein FIG. 8 illustrates an embodiment of whereby the user can change the orientation of some content on the display 302, in accordance with an embodiment. The orientation module 302 maybe configured such that, at least a part of the content on the display 102 is displayed within the orientation module 302. The user can rotate the content to the desired angle by performing touch sensitive gestures on the touch interface of the orientation module 302. The gestures can be in the form of rotating the content displayed in the orientation module 302 to the desired angle. The rotation of the content is reflected both on the display and the orientation module 302. The presence of the display content in the touch interface makes it easier for the user to choose their preferred orientation.

In an embodiment, orientation module 302 appears on the display 102, after a user makes a gesture. The gesture, for example, can be a long press made on display 102.

In an embodiment, the orientation module 302 appears on display 102 at a location on display 102 where the gesture is made.

A person skilled in the art will appreciate the advantages of the embodiments, which include enabling users to change the orientation of the content applications and change display orientation with a single finger or object. Further advantage includes changing the orientation of applications and of the content by a single touch and changing the orientation of the content and applications to any desired angle, without restriction. Furthermore, embodiments enable changing the orientation of the content displayed on the display 102, without changing the orientation of the device 100.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus the scope of the invention should be determined by the appended claims and their legal equivalents rather than by the examples given.

What is claimed is:

1. In a multiuser touch sensitive device including an orientation module capable of providing at least one touch interface and a touch sensitive display screen for displaying a content wherein the multiuser touch sensitive display device enables a plurality of users to provide touch sensitive inputs through the touch sensitive display screen and wherein not all of the plurality of users are oriented in a same direction with respect to the multiuser touch sensitive display device and to the displayed content, a method for changing an orientation of the displayed content without changing an orientation of the multiuser touch sensitive display device, the method comprising:
receiving a touch sensitive input from one of the at least one touch interface, wherein the touch sensitive input is provided by one of the plurality of users using a single object for changing the orientation of the displayed content; and
processing the received touch sensitive input at the orientation module for changing the orientation of the displayed content such that the displayed content can be oriented towards at least one of the plurality of users for viewing the displayed content at a desired orientation.

2. The method of claim 1, wherein the one of the at least one touch interface appears oriented for the one of the plurality of users on the touch sensitive display screen when the one of the plurality of users touch the touch sensitive display screen.

3. The method of claim 1, wherein the single object includes a finger of the one of the plurality of users.

4. In a multiuser touch sensitive display device including an orientation module capable of providing a plurality of touch interfaces and a touch sensitive display screen capable of displaying a plurality of windows, each window providing a user interface of a running instance of an application program for receiving inputs and displaying output content of the application program instance, wherein the multiuser touch sensitive display device enables a plurality of users to provide touch sensitive inputs simultaneously through the touch sensitive display screen and wherein not all of the plurality of users are oriented in a same direction with respect to the multiuser touch sensitive display device, a method for changing an orientation of at least one of the plurality of windows without changing an orientation of the multiuser touch sensitive display device, the method comprising:
receiving touch sensitive inputs from at least one of the plurality of touch interfaces, each touch interface associated with one of the plurality of windows for changing an orientation of the associated window, wherein each of the touch sensitive inputs is provided by one of the plurality of users using a single object for changing an orientation of the each associated window; and
processing the received touch sensitive inputs at the orientation module for changing an orientation of the each associated window such that the each associated window can be oriented towards at least one of the plurality of users for viewing the each associated window at a desired orientation angle.

5. The method of claim 4, wherein the desired orientation angle of the each associated window includes an angle that is smaller than a 90-degree angle.

6. In a multiuser touch sensitive display device including an orientation module capable of providing a plurality of touch interfaces and a touch sensitive display screen capable of displaying a plurality of windows, wherein not all of the plurality of users are oriented in a same direction with respect to the multiuser touch sensitive display device, a method for changing an orientation of the entire screen including all the content and windows on the screen in steps of 90-degree angles, without changing an orientation of the multiuser touch sensitive display device, the method comprising:
receiving touch sensitive inputs from at least one of the plurality of touch interfaces, each touch interface associated with the interface for changing an orientation of the entire screen, wherein each of the touch sensitive inputs is provided by one of the plurality of users using a single object for changing an orientation of the entire screen including all its contents and windows; and
processing the received touch sensitive inputs at the orientation module for changing an orientation of the entire screen such that the entire screen can be oriented towards at least one of the plurality of users for viewing the all content and windows at a desired orientation angle.
